(19) United States
(12) Patent Application Publication
(10) Pub. No.: US 2026/0222030 A1
(43) Pub. Date: Jul. 30, 2026

(54) NETWORK ENERGY SAVING MUTING OPERATION WITH APERIODIC CHANNEL STATE INFORMATION AND APERIODIC CHANNEL STATE INFORMATION REPORT

(71) Applicant: Nokia Technologies Oy, Espoo (FI)

(72) Inventor: Naizheng ZHENG, Beijing (CN)

(21) Appl. No.: 19/145,229

(22) PCT Filed: Feb. 3, 2023
(86) PCT No.: PCT/CN2023/074416

§ 371 Date: Jul. 2, 2025

(51) Int. Cl. H04B 7/06; H04L 27/26; H04W 24/10; H04W 72/232

(52) U.S. Cl. CPC H04B 7/0626; H04L 27/261; H04W 24/10; H04W 72/232

(57) ABSTRACT

Systems, methods, apparatuses, and computer program products for muting operation for network energy saving, involving aperiodic channel state information and aperiodic channel state information reporting are provided. For example, a method can include a user equipment receiving a channel state information reporting configuration from a network, wherein the channel state information reporting configuration indicates a plurality of configurations. The method can also include the user equipment receiving a triggering message from the network. The triggering message can indicate that the user equipment is to measure and report regarding a first configuration of the plurality of configurations and a second configuration of the plurality of configurations. The method also includes measuring a first reference signal and a second reference signal and reporting the measurements.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to muting operation for network energy saving, involving aperiodic channel state information and aperiodic channel state information reporting.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus may include at least one processor and at least memory storing instructions. The instructions, when executed by the at least one processor, may cause the apparatus at least to perform receiving a channel state information reporting configuration from a network, wherein the channel state information reporting configuration indicates a plurality of configurations. A triggering message is received from the network, wherein the triggering message indicates that the apparatus is to measure and report regarding a first configuration of the plurality of configurations and a second configuration of the plurality of configurations. A first reference signal corresponding to the first configuration of the plurality of configurations is measured, at a first predetermined slot. A second reference signal corresponding to the second configuration of the plurality of configurations is measured, at a second predetermined slot. A first measurement of the first reference signal from the apparatus is reported, and a second measurement of the second reference signal from the apparatus is reported.

Another embodiment may be directed to an apparatus. The apparatus may include at least one processor and at least memory storing instructions. The instructions, when executed by the at least one processor, may cause the apparatus at least to perform providing a channel state information reporting configuration to a user equipment, wherein the channel state information reporting configuration indicates a plurality of configurations. A triggering message is provided to the user equipment, wherein the triggering message indicates that the user equipment is to measure and report regarding a first configuration of the plurality of configurations and a second configuration of the plurality of configurations. A first reference signal corresponding to the first configuration of the plurality of configurations is provided, at a first predetermined slot, and a second reference signal corresponding to the second configuration of the plurality of configurations is provided at a second predetermined slot. A first report of the first reference signal is provided from the user equipment, and a second report of the second reference signal is received from the user equipment.

Another embodiment may be directed to a method. The method can include receiving, at a user equipment, a channel state information reporting configuration from a network, wherein the channel state information reporting configuration indicates a plurality of configurations. A triggering message is received from the network, wherein the triggering message indicates that the apparatus is to measure and report regarding a first configuration of the plurality of configurations and a second configuration of the plurality of configurations. A first reference signal corresponding to the first configuration of the plurality of configurations is measured, at a first predetermined slot, and a second reference signal corresponding to the second configuration of the plurality of configurations is measured, at a second predetermined slot. A first measurement of the first reference signal from the user equipment is reported, and a second measurement of the second reference signal from the user equipment is measured.

Another embodiment may be directed to a method. The method can include providing, by a network node, a channel state information reporting configuration to a user equipment, wherein the channel state information reporting configuration indicates a plurality of configurations. A triggering message is provided to the user equipment, wherein the triggering message indicates that the user equipment is to measure and report regarding a first configuration of the plurality of configurations and a second configuration of the plurality of configurations. A first reference signal corresponding to the first configuration of the plurality of configurations is provided, at a first predetermined slot, and a second reference signal corresponding to the second configuration of the plurality of configurations is provided at a second predetermined slot. A first report of the first reference signal is received from the user equipment, and a second report of the second reference signal is received from the user equipment.

Another embodiment can be directed to an apparatus. The apparatus can include first receiving means for receiving a channel state information reporting configuration from a network, wherein the channel state information reporting configuration indicates a plurality of configurations, and second receiving means for receiving a triggering message from the network, The triggering message indicates that the apparatus is to measure and report regarding a first configuration of the plurality of configurations and a second configuration of the plurality of configurations. First measuring means measure a first reference signal corresponding to the first configuration of the plurality of configurations, at a first predetermined slot, and second measuring means measure a second reference signal corresponding to the second configuration of the plurality of configurations, at a second predetermined slot. First reporting means report a first measurement of the first reference signal from the apparatus, and second reporting means report a second measurement of the second reference signal from the apparatus.

Another embodiment can be directed to an apparatus. The apparatus can include first providing means for providing a channel state information reporting configuration to a user equipment, wherein the channel state information reporting configuration indicates a plurality of configurations. second providing means provide a triggering message to the user equipment, wherein the triggering message indicates that the user equipment is to measure and report regarding a first configuration of the plurality of configurations and a second configuration of the plurality of configurations. Third providing means provides a first reference signal corresponding to the first configuration of the plurality of configurations, at a first predetermined slot. Fourth providing means provides a second reference signal corresponding to the second configuration of the plurality of configurations, at a second predetermined slot. First receiving means receives a first report of the first reference signal from the user equipment, and second receiving means receives a second report of the second reference signal from the user equipment.

### BRIEF DESCRIPTION OF THE DRAWINGS

For proper understanding of example embodiments, reference should be made to the accompanying drawings, wherein:

FIG. 1 illustrates timing of aperiodic channel state information reporting;

FIG. 2 illustrates timing of aperiodic channel state information reporting, according to certain embodiments

FIG. 3 illustrates another timing of aperiodic channel state information reporting, according to certain embodiments

FIG. 4 illustrates muting patterns with 32 antenna ports, according to certain embodiments; and

FIG. 5 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing muting operation for network energy saving, involving aperiodic channel state information and aperiodic channel state information reporting, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Network (NW) energy saving (ES) can rely on various NW ES techniques in time, frequency, spatial/antenna, and power domain. In spatial and power domains there may be the need for enhancements on channel state information (CSI) and beam management (BM) related procedures including measurement and report, and signaling to enable efficient adaptation of spatial elements, such as antenna ports and active transceiver chains. There may likewise be the need for enhancements of CSI related procedures including measurement and report, and signaling to enable efficient adaptation of power offset values between physical downlink shared channel (PDSCH) and CSI reference signal (CSI-RS).

Compared with fourth generation (4G) long term evolution (LTE), the fifth generation (5G) new radio (NR) provides improved in spatial domain as to average user/cell throughput and service quality with one of the approaches being the usage of antenna arrays having a large number of antenna elements, called massive multiple-input/multiple-output (MIMO). The power consumption of a massive MIMO base station (BS) is determined by the hardware that drive the high number of antenna ports and elements. Power consumption can scale with the applied hardware, such as the numbers of transceiver chains with power amplifiers (PAs) applied. Likewise, the baseband processing power can scale with the number of active antennas. Practically, important/significant energy can be saved for the massive MIMO BS by using only a subset of the available BS antennas and/or transceiver modules, such as switching off certain transceiver chains.

For MIMO operation in 5G NR, the antenna array muting and/or MIMO layer adaptation may operate at rather large time scale, due to large antenna activation delays in hardware. For release 16 (Rel.16) UE power saving, the maximum number of downlink (DL) MIMO layers can be configured per bandwidth part (BWP) via semi-static radio resource control (RRC) signaling.

For spatial/antenna-domain power saving schemes, the number of antenna elements per physical antenna array may be reduced, while keeping the number of antenna ports or logical antenna array unchanged. With antenna elements reduction from 4 X-pol per array to 1 X-pol per array while keeping the 64 antenna port unchanged, there may be power saving gains in terms of sensible spectral efficiency and average UE throughput impact. Practically adapting the antenna elements per physical antenna array can be achieved via implementation with operation which can be transparent to user equipment (UEs).

With another approach for spatial/antenna-domain power saving, the number of logical antenna ports for power saving may be reduced, where the network may switch-off a certain number of transceiver chains, especially at low load. Typically, each cross polar antenna can be connected to two transceiver chains, where each transceiver chain can be connected to one of the polarizations. This approach may achieve even better power saving gain compared with elements reduction per physical antenna array. Switching off part of the logical antenna ports, for example from 64 antenna ports to 16 antenna ports, in a semi-static manner, while keeping the number of elements per antenna array unchanged, may lead to performance and system impact with reduced antenna gain, either horizontally or vertically depending on the applied schemes. The performance impact can be higher for frequency range 2 (FR2) than for frequency range 1 (FR1) in terms of cell coverage consideration. The network next generation node B (gNB) may adapt the number of transceiver chains to serve UEs, for example in terms of UE location such as cell edge or cell center, or in terms of guaranteed data rate. From specifications perspective, the dynamic antenna port muting at the network side may result in transceiver (TRX) configuration variation, and potentially with UE beam selection impact.

It may be possible to semi-statically configure the UE with multiple CSI-ReportConfig configurations, where different number of ports parameter, nrofPorts, configured in different CSI-ReportConfig may correspond to the different transceiver muting pattern. The UE may report the CSI feedback for different transceiver muting pattern with different CSI-ReportConfig configurations. There may be many transceiver muting layouts that may eventually utilize multiple CSI-ReportConfig configurations. There may be a limitation on the UE capability to support the number of CSI reports, such as capability so support the number of CSI-ReportConfig including 4 P/SP/A-CSI ReportConfig per BWP and 8 simultaneous reports per CC, or CSI-resourceConfig including 256 total ports per band. Consuming numerous CSI reports for transceiver muting operation may impact the operations of other features that require CSI reports.

Transceiver muting operation may be beneficial for NW ES without much performance impact, when the traffic and resource utilization may be low with transmission capacity redundancy. By utilizing a mechanism with semi-static spatial adaptation, the rather slow changing of transceiver muting layout may not track exactly the traffic and/or resource utilization variations, which may lead to impact on coverage and user perceived throughput (UPT) performance. A more dynamic antenna port muting with transceiver muting adaptation can accurately fit the service and bring better ES performance.

Dynamic antenna port muting/adaptation can be achieved by dynamically enabling/disabling at least one port subset, for one or more CSI-RS resources. When dynamically disabling/enabling a port subset, the implications of such adaptation on some CSI-RS configuration parameters can be achieved for instance via legacy codebook-subset restriction (CBSR) that can be configured in CSI-ReportConfig. Alternatively, one may also leverage some existing operation(s) to carry the indication of disabling/enabling antenna ports. For instance, ZP-CSI-RS related operation may be considered, as the network may need to trigger ZP-CSI-RSs for the UE in case of dynamic port disabling/enabling.

An additional aspect to consider is the impact of dynamic port adaptation on UE measurements and reporting. When a port subset is dynamically disabled using indication sent to the UE, the impact of this disabling and corresponding indicated/determined CBSR may need to be considered. For instance, the UE may not carry measurements and/or reporting corresponding to this port subset. On the other side, when the port subset is re-enabled, the UE may need to reintegrate or reconsider those ports in the measurements and/or reporting.

CSI-RSs may be used for various purposes in NR. CSI-RSs may be used in DL CSI acquisition, and can be used to derive measurements for mobility and beam management, as well as for interference measurements. In NR, a UE can be configured with one or several CSI-RS resource-set, where each CSI-RS resource-set may include one or several configured CSI-RS resource(s) or synchronization signal block (SSB)-block resource(s). A CSI-RS resource-set can be operated as periodic, semi-persistent, or aperiodic. A CSI-RS resource can be configured with up to 32 logical antenna ports, and the density is configurable. In the time domain, a CSI-RS resource may start at any orthogonal frequency division multiplexed (OFDM) symbol of a slot and it spans 1, 2, or 4 OFDM symbols depending on the number of ports configured.

The UE can be configured with one or more non-zero power (NZP) CSI-RS resource set configuration(s) as indicated by the higher layer parameters CSI-ResourceConfig, and NZP-CSI-RS-ResourceSet. Each NZP CSI-RS resource set can include K>=1 NZP CSI-RS resource(s).

Various parameters for which the UE may assume non-zero transmission power for CSI-RS resource can be configured via the higher layer parameter NZP-CSI-RS-Resource, CSI-ResourceConfig and NZP-CSI-RS-ResourceSet for each CSI-RS resource configuration: nzp-CSI-RS-Resourceld can determine CSI-RS resource configuration identity; resourceMapping can define the number of ports, code division multiplexed (CDM)-type, and OFDM symbol and subcarrier occupancy of the CSI-RS resource within a slot th; nrofPorts in resourceMapping defines the number of CSI-RS ports; powerControlOffset, which can provide an assumed ratio of PDSCH energy per resource element (EPRE) to NZP CSI-RS EPRE when UE derives CSI feedback; powerControlOffsetSS, which can be the assumed ratio of NZP CSI-RS EPRE to synchronization signal (SS)/physical broadcast channel (PBCH) block EPRE; and BWP-Id in CSI-ResourceConfig, which can define the bandwidth part in which the configured CSI-RS is located. All CSI-RS resources within one set can be configured with same density and same nrofPorts, except for the NZP CSI-RS resources used for interference measurement.

In NR, as noted above, the configuration related to the CSI-RS transmission can include a list of CSI-RS resource-sets, as described with relation to CSI-ResourceConfig in third generation partnership project (3GPP) technical specification (TS) 38.331, in which each set can include certain CSI-RS resources. For semi-persistent and aperiodic CSI-RS, the actual triggering of CSI-RS transmission is per CSI-RS resource-set via either medium access control (MAC) control element (CE) or downlink control information (DCI). A resource set can be used as part of UE report configurations describing what is to be measured and, correspondingly, what measurement reporting is to be done by the UE.

Specifically, if a CSI-RS resource-set is configured as ‘aperiodic’ by RRC, the CSI-RS resource set configuration includes a slot offset, aperiodicTriggeringOffset, which can also be referred to as offset X, which can define the time interval between the triggering DCI and the CSI-RS transmission. When aperiodic CSI-RS is triggered, the gNB can send CSI-RS according to the slot offset defined by RRC. The UE can receive the CSI-RS within the indicated slot accordingly.

Likewise, the UE measurement reporting of CSI can also be operated in a periodic, semi-persistent, or aperiodic manner, which is so-called report types in NR CSI-ReportConfig configuration. The UE periodic report may operate based on the configured periodic CSI-RS resource-set. The UE semi-persistent report may operate based on both configured periodic and semi-persistent CSI-RS resource-set. The UE aperiodic report may operate based on all periodic, semi-persistent, and aperiodic CSI-RS resource-set. Thus, the periodic CSI-RS resources may be used to generate any report type, the semi-persistent and periodic CSI-RS resources may be used to generate semi-persistent CSI reports, and the aperiodic CSI-RS may be utilized to generate the aperiodic report.

If ‘aperiodic’ CSI report is configured, the CSI-ReportConfig can include a list of slot offsets, reportSlotOffsetList, also referred to as offset Y, which can define the time gap between aperiodic CSI reporting triggering DCI, such as 0_1/0_2, and aperiodic CSI reporting with respect to the number of slots. The time domain resource allocation (TDRA) information element (IE) in aperiodic CSI reporting triggering DCI (0_1/0_2) can indicate the index in reportSlotOffsetList on the exact timing between aperiodic CSI reporting triggering DCI and aperiodic CSI reporting. The timing can relate to aperiodic CSI-RS transmission and aperiodic reporting.

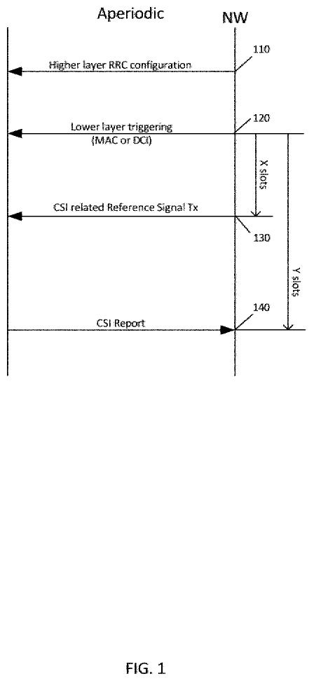

FIG. 1 illustrates timing of aperiodic channel state information reporting. As shown in FIG. 1 there can be communication between a user equipment and a network element, such as a gNB. The NW can send higher layer configuration, for example using RRC, to the UE at 110. At 120, the NW can send a low layer trigger, for example using MAC CE or DCI. After X slots, corresponding to offset X, the NW can send a CSI-related reference signal at 130. At 140, after Y slots, corresponding to offset Y, from the low layer trigger at 120, the UE may send a CSI report to the network.

Considering the dynamic adaptation of NW transceiver muting pattern operation, for assisting the NW to make decision on which transceiver muting pattern to apply, the NW may request the UEs to provide the CSI reports corresponding to each of the transceiver muting pattern. Specifically for aperiodic CSI report operation, certain embodiments may relate to the timing issues for aperiodic CSI transmissions and reporting with respect to different logical antenna ports configuration that is to be measured by the UEs.

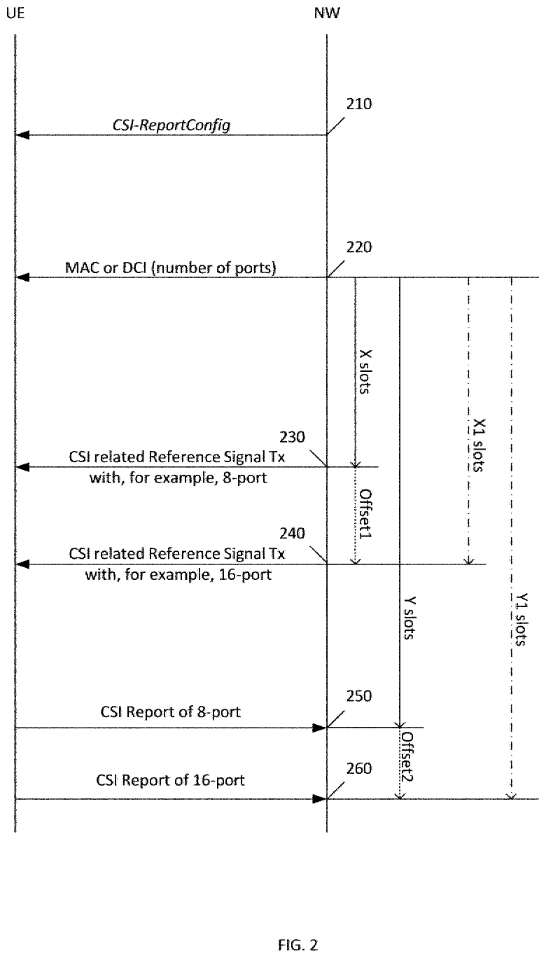

FIG. 2 illustrates timing of aperiodic channel state information reporting, according to certain embodiments. As shown at 210, a CSI report configuration can be provided by the NW to the UE. Thus, a number of different ports configurations can be provided, which can be referred to as a plurality of configurations. To avoid consuming too many limited CSI report configurations, a single CSI report configuration may contain a list of nrofPorts configuration corresponding to different transceiver muting pattern. More specifically, a single CSI-ReportConfig configuration may contain a list of nrofPorts, such as 4, 8, 16, and 32-port, which may correspond to a different transceiver muting pattern(s).

At 220, the NW may trigger or otherwise tell the UE(s) what number of ports, nrofPorts, to measure. For example, a bitmap may provide to indicate 8/16-port is to be measured by UEs. Practically, the NW may only ask the UEs to report some of the transceiver muting pattern configuration with respect to the logical antenna port configuration. For example, an IE in MAC or DCI can indicate to UEs as to which nrofPorts(s) is/are to be measured and reported from the list of configurations provided at 210. Thus, for example, at 220, MAC/DCI may indicate to UEs to make measurements on 8 and 16 ports.

At 230, after X slots from 220, the NW can send CSI-related reference signal with, for example, 8 ports. The UE can measure these CSI-related reference signals. At 240, after X slots plus offset 1 from 220, the NW can send CSI-related reference signal with, for example, 16 ports. The UE can measure these CSI-related reference signals. The offset 1 is shown as greater than zero. When the offset 1 is zero, the RS of 8 and 16 ports can be transmitted in the same slot at different symbols.

To define the timing relation between the triggering DCI and multiple CSI transmissions with different logical antenna ports, an offset 1 with respect to offset X can be configured for each subsequent CSI transmission. By default, or if not configured, or if offset 1 is equal to 0, the subsequent CSI transmission can be the same slot as the previous CSI transmission configured with different logical antenna port. As another option, there can be explicit timing in terms of number of slots from the triggering DCI, and this explicit timing can be configured for each subsequent CSI transmission. As an alternative, the timing of the 16-port CSI-related reference signal can be indicated as being X1 slots from the MAC or DCI at 220. In this way, the timing can be directly indicated, rather than being referentially indicated.

The NW can perform the CSI-RS transmission with 8-port with X slots at 230 from the time of sending the triggering DCI at 220, and the CSI-RS transmission with 16-port at 240 with X+offset 1 slots from the time sending the triggering DCI at 220. The 8-port and 16-port examples are just two examples for the purposes of illustration. The NW can perform the CSI transmissions with different logical antenna ports from one another based on the above timing configuration.

At 250, Y slots after the triggering DCI or MAC at 220, the UE can provide to the network a CSI report of the 8-port transmission. Similarly, at 260 Y plus offset 2 slots after the triggering DCI or MAC at 220, the UE can provide to the network a CSI report of the 16-port transmission. If offset 2 is 0, the measurements both of the CSI related signal provided at 230 and of the CSI related signal provided at 240 can be reported together in the same CSI feedback report.

Thus, the UE can perform the measurement on 8-port and 16-port respectively, and conduct the CSI reporting to the NW based on the configured timing. For example, at 250 the UE can report the CSI report of 8-port with Y slots from the time sending the triggering DCI, and at 260 can report the CSI-RS report with 16-port with Y+offset 2 slots from the time of sending the triggering DCI.

To define the timing relation between the triggering DCI and multiple CSI reportings corresponding to the UE measurement of different logical antenna ports, an offset from the offset Y can be configured for each subsequent CSI reporting corresponding to each configured logical antenna ports. By default, or if not configured, or if offset 2 is equal to 0, the subsequent multiple CSI reportings can be carried in the same CSI feedback report. As another alternative, there can be explicit timing in terms of number of slots from the triggering DCI can be configured for each subsequent CSI reporting corresponding to each configured logical antenna ports. As an alternative, the timing of the reporting of the 16-port CSI-related reference signal can be indicated as being Y1 slots from the MAC or DCI at 220. In this way, the timing can be directly indicated, rather than being referentially indicated.

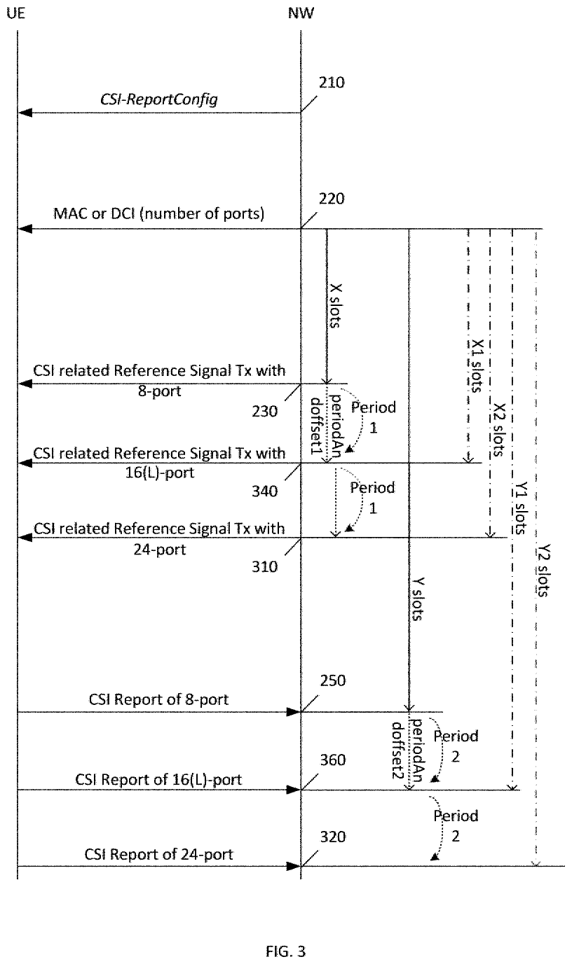

FIG. 3 illustrates another timing of aperiodic channel state information reporting, according to certain embodiments. For assisting the NW to make a decision on which transceiver muting pattern to apply, as shown at 210, a CSI report configuration can be provided by the NW to the UE. Thus, a number of different ports configurations can be provided, which can be referred to as a plurality of configurations. To avoid consuming too many limited CSI report configurations, a single CSI report configuration may contain a list of nrofPorts configuration corresponding to different transceiver muting pattern. More specifically, a single CSI-ReportConfig configuration may contain a list of nrofPorts, such as 4, 8, 16(L), 16(R), 24, and 32-port, which may correspond to a different transceiver muting pattern(s). For example, 16(L) can correspond to the left 16 ports of a panel being active, and 16(R) can correspond to the right 16 ports of the panel being active.

At 220, the NW may trigger or otherwise tell the UE(s) what number of ports, nrofPorts, to measure. For example, a bitmap may provide to indicate 8/16(L)/24-port is to be measured by UEs. Practically, the NW may only ask the UEs to report some of the transceiver muting pattern configuration with respect to the logical antenna port configuration. For example, an IE in MAC or DCI can indicate to UEs as to which nrofPorts(s) is/are to be measured and reported from the list of configurations provided at 210. Thus, for example, at 220, MAC/DCI may indicate to UEs to make measurements on 8, 16(L), and 24 ports.

At 230, after X slots from 220, the NW can send CSI-related reference signal with, for example, 8 ports. The UE can measure these CSI-related reference signals. At 340, after X slots plus periodAndoffset1 from 220, the NW can send CSI-related reference signal with, for example, 16(L) ports. The UE can measure these CSI-related reference signals. The periodAndoffset1 is shown as greater than zero. When the periodAndoffset1 is zero, the RS of 8 and 16 ports can be transmitted in the same slot at different symbols. The parameter periodAndoffset1 can be both an offset amount and can also indicate a period, period1. After another period1 slots, at 310 the network can transmit a CSI-related signal with, for example, 24-port.

To define the timing relation between the triggering DCI and multiple CSI transmissions with different logical antenna ports, the period1 with respect to offset X can be configured for each subsequent CSI transmission. By default, or if not configured, or if offset 1 is equal to 0, the subsequent CSI transmission can be the same slot as the previous CSI transmission configured with different logical antenna port. As another option, there can be explicit timing in terms of number of slots from the triggering DCI, and this explicit timing can be configured for each subsequent CSI transmission. As an alternative, the timing of the 16-port CSI-related reference signal can be indicated as being X1 slots from the MAC or DCI at 220. In this way, the timing can be directly indicated, rather than being referentially indicated.

The NW can perform the CSI-RS transmission with 8-port with X slots at 230 from the time of sending the triggering DCI at 220, and the CSI-RS transmission with 16(L)-port at 340 with X+offset 1 slots from the time sending the triggering DCI at 220, and the CSI-RS transmission with 24-port with (X+Offset1P) slots from the time sending the triggering DCI. The 8-port and 16-port examples are just two examples for the purposes of illustration. The NW can perform the CSI transmissions with different logical antenna ports from one another based on the above timing configuration.

At 250, Y slots after the triggering DCI or MAC at 220, the UE can provide to the network a CSI report of the 8-port transmission. Similarly, at 360 Y plus periodAndoffset2 slots after the triggering DCI or MAC at 220, the UE can provide to the network a CSI report of the 16-port transmission. If periodAndoffset2 is 0, the measurements both of the CSI related signal provided at 230 and of the CSI related signal provided at 340 can be reported together in the same CSI feedback report.

Thus, the UE can perform the measurement on 8, 16(L), and 24-port respectively, and conduct the CSI reporting to the NW based on the configured timing. For example, at 250 the UE can report the CSI report of 8-port with Y slots from the time sending the triggering DCI, and at 360 can report the CSI-RS report with 16(L)-port with Y+offset 2 slots from the time of sending the triggering DCI, while at 320 can report the CSI-RS report with 24-port with (Y+Offset2+P) slots from the time of sending the triggering DCI.

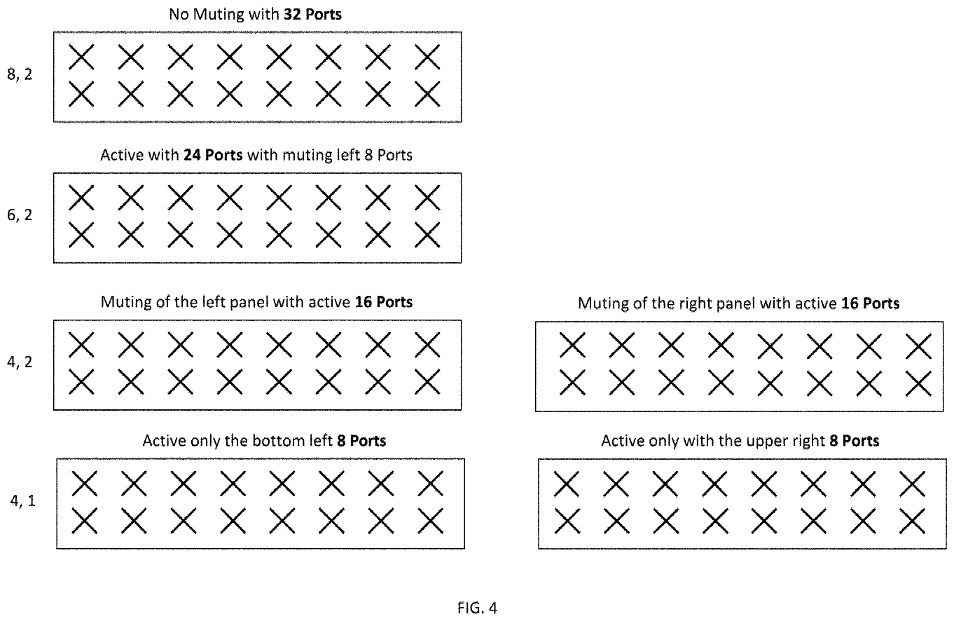

FIG. 4 illustrates muting patterns with 32 antenna ports, according to certain embodiments. By taking 32 antenna ports with (N1, N2)=(8, 2) as an example, the muting layouts as shown in FIG. 4 can be considered by the network, in which the black crosses are unmuted and the grey crosses are muted. This is a single panel case as an example. The numbering of the various patterns can correspond to 3GPP TS 38.214 v15.3-Table 5.2.2.2.2-1. The number of CSI-RS antenna ports supported can be, for example, 4, 8, 12, 16, 24 and 32.

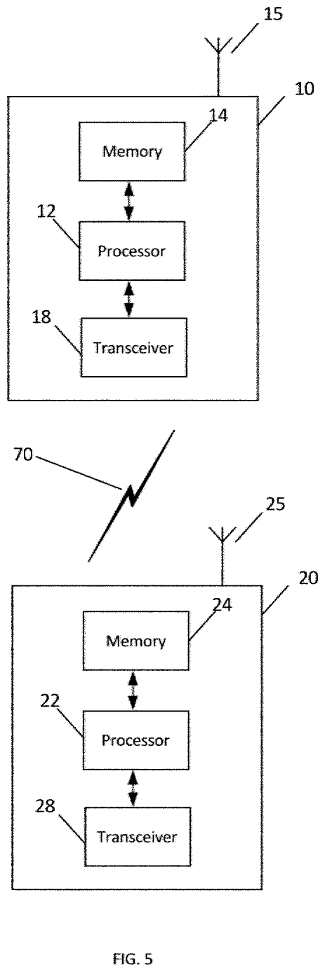

FIG. 5 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as an LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 5.

As illustrated in the example of FIG. 5, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 5, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to muting operation for network energy saving, involving aperiodic channel state information and aperiodic channel state information reporting.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1 and 2, or any other method described herein. In some embodiments, as discussed herein, apparatus 10 may be configured to perform a procedure relating to providing muting operation for network energy saving, involving aperiodic channel state information and aperiodic channel state information reporting, for example.

FIG. 5 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5.

As illustrated in the example of FIG. 5, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1 and 2, or any other method described herein. For example, in an embodiment, apparatus 20 may be controlled to perform a process relating to providing muting operation for network energy saving, involving aperiodic channel state information and aperiodic channel state information reporting, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, certain embodiments permit the efficient operation of network saving muting operation even in the case of the use of aperiodic CSI and aperiodic CSI reporting. Similarly, certain embodiments may enhance efficiency of operation in the case of semi-persistent CSI and semi-persistent CSI reporting, or periodic CSI and semi-persistent CSI reporting, or periodic CSI and any report type.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

In some embodiments, means can be provided in an user equipment wherein the channel state information reporting configuration comprises a number of different port configurations corresponding to a plurality of different transceiver muting patterns.

In some embodiments, means can be provided in user equipment wherein the triggering message is provided as an information element in downlink control information or a control element of a medium access control message.

In some embodiments, means can be provided in user equipment wherein the triggering message comprises an indication of specific antenna ports to be measured.

In some embodiments, means can be provided in user equipment wherein the triggering message indicates a first offset between the first reference signal and the second reference signal.

In some embodiments, means can be provided in user equipment wherein when the first offset is zero, the first reference signal and the second reference signal are measured in a same slot.

In some embodiments, means can be provided in user equipment wherein the triggering message indicates transmission timing of subsequent reference signals with different antenna ports, as a reference to transmission timing of the first reference signal.

In some embodiments, means can be provided in user equipment wherein subsequent reference signals to the first reference signal are provided with periodic transmission with different antenna ports from the time as reference to the timing of first reference signal.

In some embodiments, means can be provided in user equipment wherein the triggering message indicates transmission timing of subsequent measurement reporting with different antenna ports, as a reference to transmission timing of the first measurement reporting.

In some embodiments, means can be provided in user equipment wherein subsequent measurement reportings are provided with periodic transmission with different antenna ports from the time as reference to the timing of the first measurement reporting.

In some embodiments, means can be provided in user equipment wherein the triggering message separately indicates a first timing of the first reference signal and a second timing of the second reference signal.

In some embodiments, means can be provided in user equipment wherein transmission timing of subsequent reference signals with different antenna ports is explicitly signaled, as a time from receiving of the triggering message.

In some embodiments, means can be provided in user equipment wherein the triggering message indicates a second offset between the reporting the first measurement and the reporting the second measurement.

In some embodiments, means can be provided in user equipment wherein when the second offset is zero, the reporting the first measurement and the reporting the second measurement are performed in a same slot.

In some embodiments, means can be provided in user equipment wherein the triggering message separately indicates a third timing of the reporting the first measurement and a fourth timing of the reporting the second measurement.

In some embodiments, means can be provided in a network node wherein the channel state information reporting configuration comprises a number of different ports configurations corresponding to a plurality of different transceiver muting patterns.

In some embodiments, means can be provided in a network node wherein the triggering message is provided as an information element in downlink control information or a control element of a medium access control message.

In some embodiments, means can be provided in a network node wherein the triggering message indicates a first offset between the first reference signal and the second reference signal.

In some embodiments, means can be provided in a network node wherein when the first offset is zero, the first reference signal and the second reference signal are provided in a same slot.

In some embodiments, means can be provided in a network node wherein the triggering message indicates transmission timing of subsequent reference signals with different antenna ports, as a reference to transmission timing of the first reference signal.

In some embodiments, means can be provided in a network node wherein subsequent reference signals to the first reference signal are provided with periodic transmission with different antenna ports from the time as reference to the timing of first reference signal.

In some embodiments, means can be provided in a network node wherein the triggering message separately indicates a first timing of the first reference signal and a second timing of the second reference signal.

In some embodiments, means can be provided in a network node wherein transmission timing of subsequent reference signals with different antenna ports is explicitly signaled, as a time from receiving of the triggering message.

In some embodiments, means can be provided in a network node wherein the triggering message indicates a second offset between the first report and the second report.

In some embodiments, means can be provided in a network node wherein when the second offset is zero, the reporting the first measurement and the reporting the second measurement are performed in a same slot.

In some embodiments, means can be provided in a network node wherein the triggering message separately indicates a third timing of the first report and a fourth timing of the second report.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

PARTIAL GLOSSARY:

| | |
|---|---|
| 3GPP | Third Generation Partnership Project |
| 4G | Fourth Generation |
| 5G | Fifth Generation (5G) |
| BM | Beam Management |
| BS | Base Station |
| BWP | Bandwidth Part |
| CBSR | Codebook Subset Restriction |
| CDM | Code Division Multiplexed |
| CE | Control Element |
| CSI | Channel State Information |
| CSI-RS | CSI Reference Signal |
| DCI | Downlink Control Information |
| DL | Downlink |
| EPRE | Energy Per Resource Element |
| ES | Energy Saving |
| FR1 | Frequency Range 1 - frequency bands up to 7 |
| | GHz |
| FR2 | Frequency Range 2 - frequency bands |
| | approximately from 24.25 GHz to 52.6 GHz |
| GHz | Gigahertz |
| gNB | Next Generation Node B |
| IE | Information Element |
| LTE | Long Term Evolution |
| MAC | Medium Access Control |
| MIMO | Multiple-Input/Multiple-Output |
| NR | New Radio |
| NW | Network |
| NZP | Non-Zero Power |
| OFDM | Orthogonal Frequency Division |
| | Multiplex(-ed)(-ing) |
| PA | Power Amplifier |
| PBCH | Physical Broadcast Channel |
| PDSCH | Physical Downlink Shared Channel |
| Rel. 16 | Release 16 |
| RRC | Radio Resource Control |
| SS | Synchronization Signal |
| SSB | Synchronization Signal Block |
| TDRA | Time Domain Resource Allocation |
| TRX | Transceiver |
| TS | Technical Specification |
| UE | User Equipment |
| UPT | User Perceived Throughput |

1. An apparatus, comprising:
at least one processor; and
at least one memory storing instructions that, when executed by the at least one processor, cause the apparatus at least to perform
receiving a channel state information reporting configuration from a network, wherein the channel state information reporting configuration indicates a plurality of configurations;
receiving a triggering message from the network, wherein the triggering message indicates that the apparatus is to measure and report regarding a first configuration of the plurality of configurations and a second configuration of the plurality of configurations;
measuring a first reference signal corresponding to the first configuration of the plurality of configurations, at a first predetermined slot;
measuring a second reference signal corresponding to the second configuration of the plurality of configurations, at a second predetermined slot;
reporting a first measurement of the first reference signal from the apparatus; and
reporting a second measurement of the second reference signal from the apparatus.

2. The apparatus of claim 1, wherein the channel state information reporting configuration comprises a number of different port configurations corresponding to a plurality of different transceiver muting patterns.

3. The apparatus of claim 1, wherein the triggering message is provided as an information element in downlink control information or a control element of a medium access control message.

4. The apparatus of claim 1, wherein the triggering message comprises an indication of specific antenna ports to be measured.

5. The apparatus of claim 1, wherein the triggering message indicates a first offset between the first reference signal and the second reference signal.

6. The apparatus of claim 5, wherein when the first offset is zero, the first reference signal and the second reference signal are measured in a same slot.

7. The apparatus of claim 1, wherein the triggering message indicates transmission timing of subsequent reference signals with different antenna ports, as a reference to transmission timing of the first reference signal.

8. The apparatus of claim 1, wherein subsequent reference signals to the first reference signal are provided with periodic transmission with different antenna ports from the time as reference to the timing of first reference signal.

9. The apparatus of claim 1, wherein the triggering message indicates transmission timing of subsequent measurement reporting with different antenna ports, as a reference to transmission timing of the first measurement reporting.

10. The apparatus of claim 1, wherein subsequent measurement reportings are provided with periodic transmission with different antenna ports from the time as reference to the timing of the first measurement reporting.

11. The apparatus of claim 1, wherein the triggering message separately indicates a first timing of the first reference signal and a second timing of the second reference signal.

12. The apparatus of claim 1, wherein transmission timing of subsequent reference signals with different antenna ports is explicitly signaled, as a time from receiving of the triggering message.

13. The apparatus of claim 1, wherein the triggering message indicates a second offset between the reporting the first measurement and the reporting the second measurement.

14. The apparatus of claim 13, wherein when the second offset is zero, the reporting the first measurement and the reporting the second measurement are performed in a same slot.

15. The apparatus of claim 1, wherein the triggering message separately indicates a third timing of the reporting the first measurement and a fourth timing of the reporting the second measurement.

16. An apparatus, comprising:
at least one processor; and
at least one memory storing instructions that, when executed by the at least one processor, cause the apparatus at least to perform
providing a channel state information reporting configuration to a user equipment, wherein the channel state information reporting configuration indicates a plurality of configurations;
providing a triggering message to the user equipment, wherein the triggering message indicates that the user equipment is to measure and report regarding a first configuration of the plurality of configurations and a second configuration of the plurality of configurations;
providing a first reference signal corresponding to the first configuration of the plurality of configurations, at a first predetermined slot;
providing a second reference signal corresponding to the second configuration of the plurality of configurations, at a second predetermined slot;
receiving a first report of the first reference signal from the user equipment; and
receiving a second report of the second reference signal from the user equipment.

17. The apparatus of claim 16, wherein the channel state information reporting configuration comprises a number of different ports configurations corresponding to a plurality of different transceiver muting patterns.

18. The apparatus of claim 16, wherein the triggering message is provided as an information element in downlink control information or a control element of a medium access control message.

19. The apparatus of claim 1, wherein the triggering message indicates a first offset between the first reference signal and the second reference signal.

20-27. (canceled)

28. A method, comprising:
receiving, at a user equipment, a channel state information reporting configuration from a network, wherein the channel state information reporting configuration indicates a plurality of configurations;
receiving a triggering message from the network, wherein the triggering message indicates that the apparatus is to measure and report regarding a first configuration of the plurality of configurations and a second configuration of the plurality of configurations;
measuring a first reference signal corresponding to the first configuration of the plurality of configurations, at a first predetermined slot;
measuring a second reference signal corresponding to the second configuration of the plurality of configurations, at a second predetermined slot;
reporting a first measurement of the first reference signal from the user equipment; and
reporting a second measurement of the second reference signal from the user equipment.

29-60. (canceled)
